(19) United States
(12) Patent Application Publication
(10) Pub. No.: US 2019/0128060 A1
(43) Pub. Date: May 2, 2019

(54) Oscillation and Retraction Mechanism for Window Blinds

(71) Applicant: TTI (Macao Commercial Offshore) Limited, Macau (MO)

(72) Inventor: J. Porter Whitmire, Greenville, SC (US)

(73) Assignee: TTI (Macao Commercial Offshore) Limited, Macau (MO)

(21) Appl. No.: 16/142,229

(22) Filed: Sep. 26, 2018

Related U.S. Application Data
(60) Provisional application No. 62/579,319, filed on Oct. 31, 2017.

(51) Int. Cl. E06B 9/322; E06B 9/307; F16H 19/06; F16H 1/06; F16H 19/08

(52) U.S. Cl. CPC E06B 9/322; E06B 9/307; F16H 2019/085; F16H 1/06; F16H 19/08; F16H 19/0622

(57) ABSTRACT

A window covering assembly includes a plurality of slats held by a ladder that extends between a header and a bottom rail. The bottom rail is suspended from a suspension cord that is attached to the header. An oscillation and retraction mechanism tilts and retracts or extends the blinds. The same components are used in both a tilting operation and a retraction or extension operation. An actuator is provided that selectively causes the oscillation and retraction mechanism to either tilt the slats or to retract or extend the slats.

This application claims the benefit of U.S. Provisional Application No. 62/579,319, filed Oct. 31, 2017, the contents of which are hereby incorporated by reference in their entirety.

### SUMMARY OF THE INVENTION

The present invention relates to a mechanism for manipulating a window covering assembly. In one embodiment, the window covering assembly is a window blinds assembly and the mechanism either tilts the blinds or retracts or extends the blinds. Common components are employed in these different operations. Thus, the present invention obviates the need for separate components to carry out these different operations, thereby providing a simple and economized window covering assembly.

### BRIEF DESCRIPTION OF THE DRAWINGS

FIG. 1 is a perspective view of a window covering assembly according to one embodiment of the present invention.

FIG. 2 is a perspective view of an oscillation and retraction mechanism according to one embodiment of the present invention.

FIG. 3 is a perspective view of a planetary gear assembly according to one embodiment of the present invention.

FIG. 4 is a side view of certain components of the window covering assembly according to one embodiment of the present invention.

FIG. 5 is a side view of certain components of a window covering assembly in accordance with one embodiment of the present invention and shows the movement of the components of a planetary gear assembly during a retraction operation.

FIG. 6 is a side view of certain components of a window covering assembly in accordance with one embodiment of the present invention and shows the movement of certain components of the window covering assembly during a retraction operation.

FIGS. 7 and 8 are side views of certain components of a window covering assembly in accordance with one embodiment of the present invention and show the movement of the components of a planetary gear assembly during an oscillation operation.

FIG. 9 is a side view of certain components of a window covering assembly in accordance with one embodiment of the present invention and shows the movement of certain components of the window covering assembly during an oscillation operation.

### DETAILED DESCRIPTION OF THE PREFERRED EMBODIMENT

Reference will now be made in detail to the preferred embodiment of the present invention, which is illustrated in the accompanying drawings.

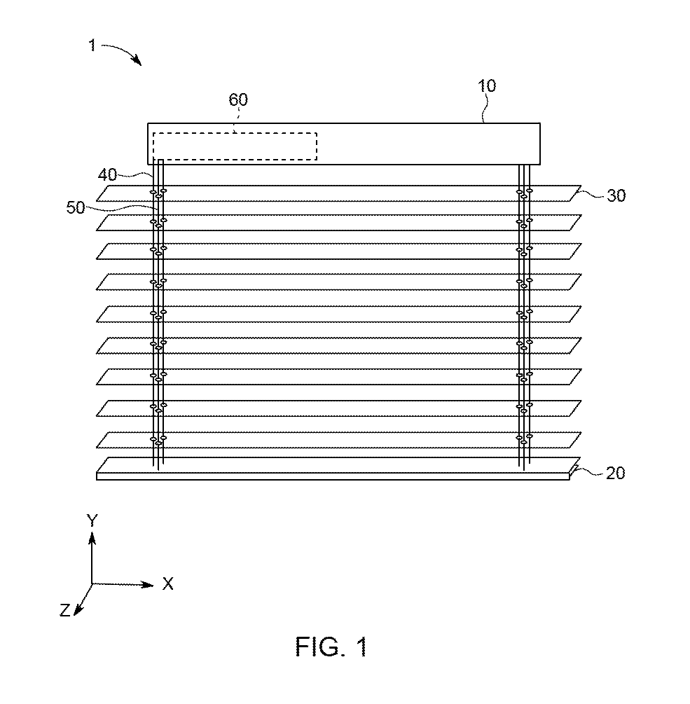

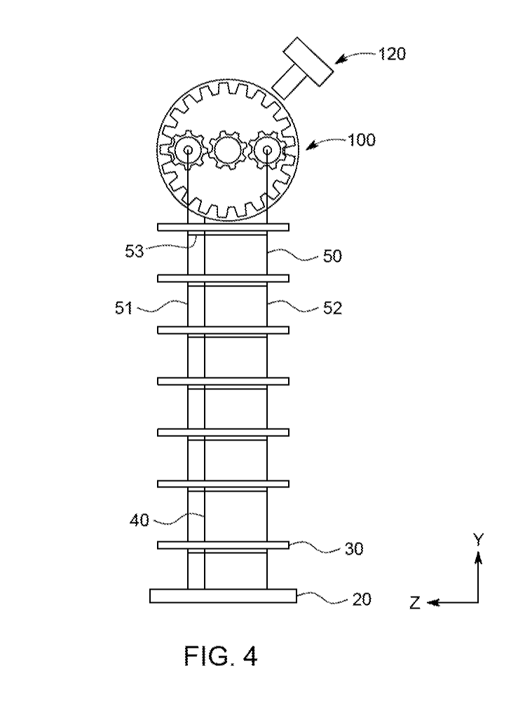

FIG. 1 shows a window covering assembly 1 according to one embodiment of the present invention. In the illustrated embodiment, window covering assembly 1 is a window blinds assembly. The window covering assembly 1 may include a header 10 and a bottom rail 20. One or more suspension cords 40 and one or more ladders 50 are suspended between header 10 and bottom rail 20. A plurality of slats 30 are held by the ladders 50. As shown in more detail in FIG. 4, each ladder 50 includes two vertical components 51 and 52 and a plurality of horizontal components 53. In one embodiment, components 51, 52, and 53 are cords, and horizontal components 53 are tied to vertical components 51 and 52 at regular intervals. The plurality of slats 30 rest on the horizontal components 53. Returning to FIG. 1, the window covering assembly 1 may also include an oscillation and retraction mechanism 60, which may be provided in header 10.

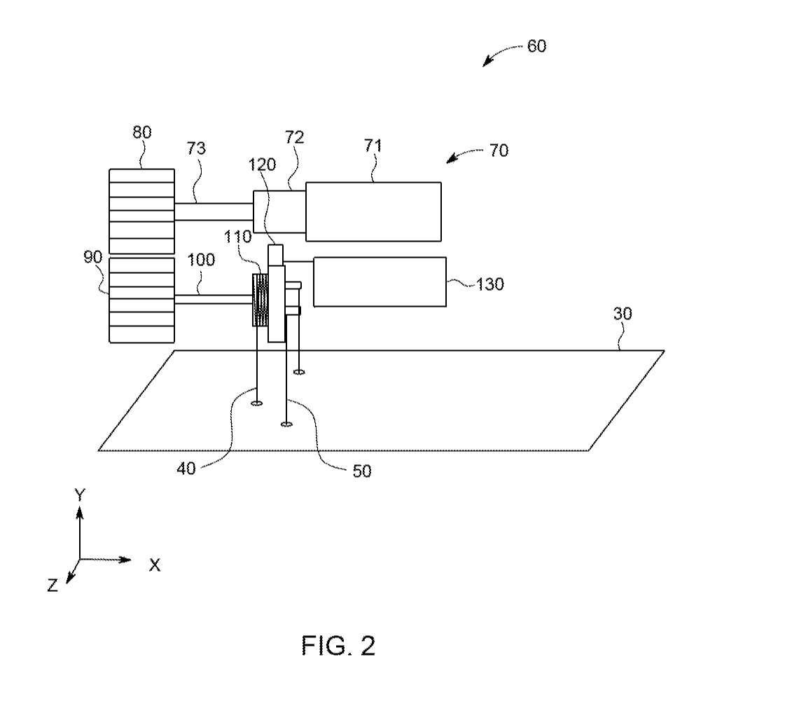

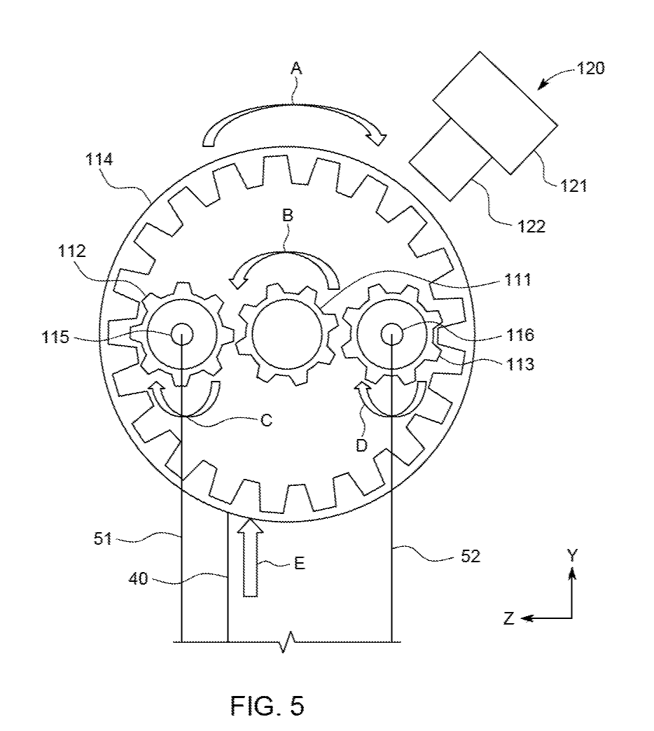

FIG. 2 shows an oscillation and retraction mechanism 60 (with header 10 removed) in accordance with one embodiment of the present invention. Surrounding components are also shown for context. In one embodiment, oscillation and retraction mechanism 60 includes a motor assembly 70, gears 80 and 90, shaft 100, planetary gear assembly 110, actuator 120, and printed circuit board assembly (“PCBA”) 130. Motor assembly 70 may include a motor 71, a gear reduction mechanism 72, and output shaft 73. In one embodiment, gear 80 is attached to output shaft 73 such that rotation of output shaft 73 causes the rotation of gear 80. Gear 80 may be a spur gear. Gear 80 interfaces with gear 90, which also may be a spur gear, such that rotation of gear 80 causes rotation of gear 90 in an opposite direction. Shaft 100 is attached to gear 90 such that rotation of gear 90 causes the rotation of shaft 100. Gears other than spur gears may be used, and the gears may be arranged in different configurations while still transmitting rotation of output shaft 73 to rotation of shaft 100. For example, gears 80 and 90 may be bevel gears, and output shaft 73 and shaft 100 may be disposed along perpendicular axes. Actuator 120 may be a solenoid with a solenoid body 121 and a plunger 122 (see FIG. 5).

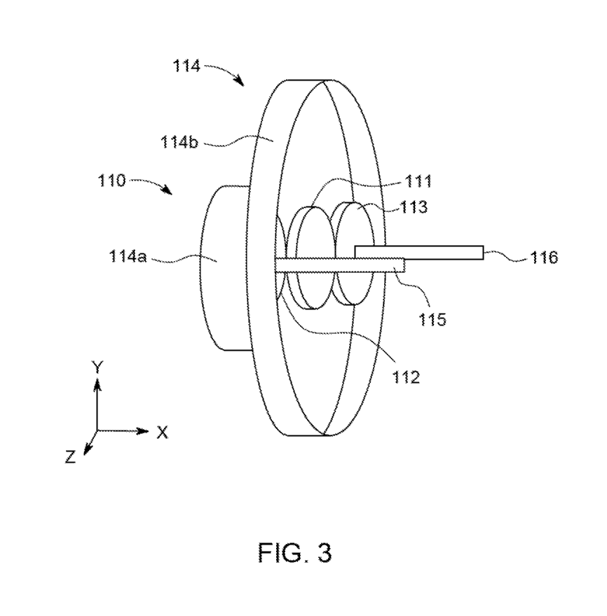

FIG. 3 shows a planetary gear assembly 110 in accordance with one embodiment of the present invention. As shown in FIG. 3, planetary gear assembly 110 may include a sun gear 111, planetary gears 112 and 113, and an internal gear 114. With reference to the coordinate system provided in FIG. 3, sun gear 111 is configured to rotate about the x-axis, and is rotated by shaft 100 (see FIG. 2). Planetary gears 112 and 113 may have extensions 115 and 116, respectively, that protrude along the x-axis. Internal gear 114 may include two segments—a small-diameter segment 114a and a large-diameter segment 114b. Large-diameter segment 114b includes teeth on its inner side for interfacing with the teeth on planetary gears 112 and 113. As shown in FIG. 2, the top of suspension cord 40 is fixed to small-diameter segment 114a. The operation of planetary gear assembly 110 is described in further detail below.

FIGS. 4-9 show operation of the oscillation and retraction mechanism according to one embodiment of the present invention.

FIG. 4 shows the window covering assembly 1 in a fully extended state with its slats 30 in the horizontal position. For clarity, only some components of the window covering assembly 1 are shown.

FIG. 5 shows the operation of the planetary gear assembly 110 in accordance with an exemplary retraction operation. As shown in FIG. 5, sun gear 111 rotates in a counter-clockwise direction (arrow B). With reference to FIG. 2, this may be effectuated by the clockwise rotation of output shaft 73 of motor assembly 70, and thus gear 80 (in the y-z plane). Gear 90 is thereby caused to rotate in a counter-clockwise direction (in the y-z plane). Shaft 100 likewise rotates in a counter-clockwise direction, and sun gear 111 rotates in the same direction. Returning to FIG. 5, the counter-clockwise rotation of sun gear 111 causes a clockwise rotation of planetary gears 112 and 113 (arrows C and D), which in turn causes the clockwise rotation of internal gear 114 (arrow A). (Because plunger 122 of actuator 120 does not contact internal gear 114, internal gear 114 is free to rotate.) As noted above, suspension cord 40 is fixed to small-diameter segment 114a of internal gear 114 (see FIG. 2). In particular, in one embodiment, relative to the center axis of internal gear 114, suspension cord 40 extends from the small diameter portion 114a of internal gear 114 on the +z side. Thus, the clockwise rotation of internal gear 114 causes suspension cord 40 to move upward (in the +y direction) (arrow E).

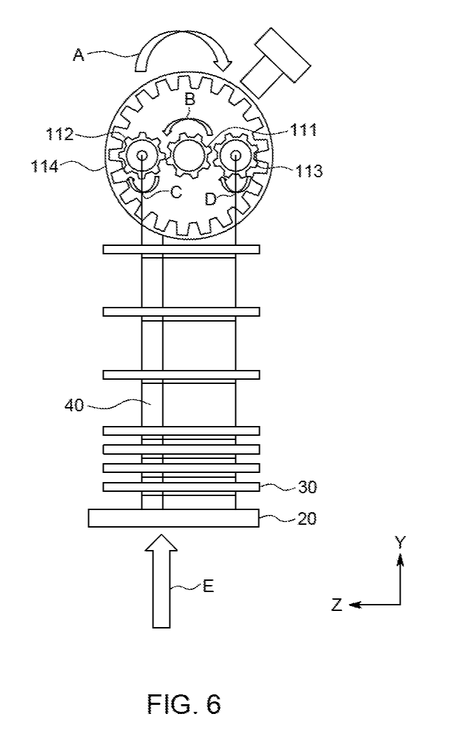

As shown in FIG. 6, the upward movement of suspension cord 40 (arrow E) results in the retraction of the slats 30. In particular, the upward movement of suspension cord 40 raises the bottom rail 20. As bottom rail 20 is raised, the slats 30 are contacted and raised by the bottom rail 20 in an ascending manner. This process continues until the retraction ceases or until the slats 30 are fully retracted.

The extension of the slats 30 may be achieved by reversing the direction of rotation of output shaft 73 of motor assembly 70.

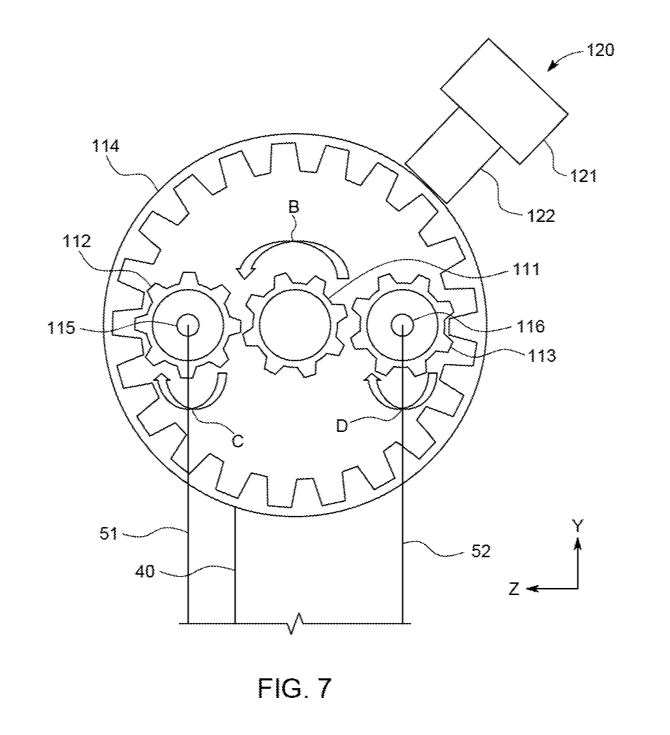

FIG. 7 shows the operation of the planetary gear assembly 110 in accordance with an exemplary oscillation operation. FIG. 7 includes the same components as shown in FIG. 5. However, whereas the plunger 122 of actuator 120 was in a retracted position in FIG. 5, in FIG. 7, the plunger 122 is in an extended position. In one embodiment, PCBA 130 instructs the actuator 120 via appropriate signals to extend the plunger 122. The actuator 120 is disposed at a distance from the internal gear shorter than the stroke length of plunger 122 such that, in the configuration in which plunger 122 is extended, it abuts internal gear 114.

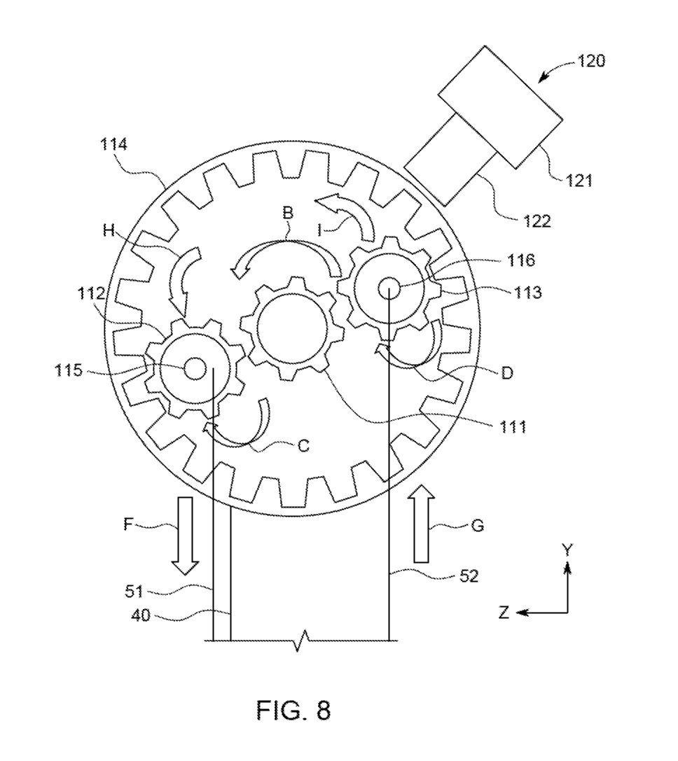

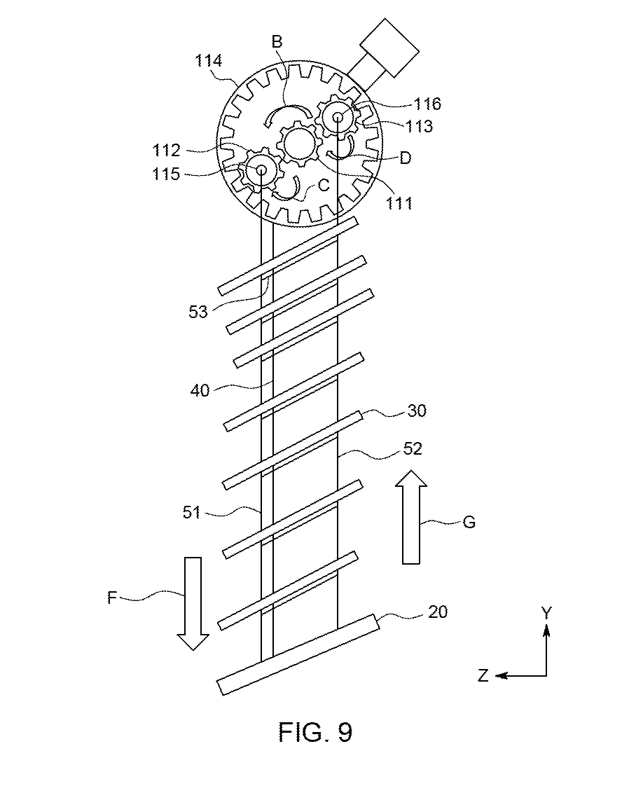

In one embodiment, sun gear 111 rotates in a counter-clockwise direction (arrow B). This rotation is effectuated in the same way as in the retraction operation discussed above. The counter-clockwise rotation of sun gear 111 causes planetary gears 112 and 113 to rotate in a clockwise direction (arrows C and D). Because internal gear 114 is held in place by plunger 122, the rotation of planetary gears 112 and 113 does not cause internal gear 114 to rotate. Rather, as shown in FIG. 8, planetary gears 112 and 113 travel along the inner side of internal gear 114 in the counter-clockwise direction (arrows H and I). Because vertical component 51 of ladder 50 is attached to extension 115, the travel of planetary gear 112 causes the downward movement (in the −y direction) of vertical component 51 (arrow F). Similarly, because vertical component 52 of ladder 50 is attached to extension 116, the travel of planetary gear 113 causes the upward movement (in the +y direction) of vertical component 52. As shown in FIG. 9, the downward movement of vertical component 51 coupled with the upward movement of vertical component 52 causes horizontal components 53 of ladder 50 to tilt. Slats 30 likewise tilt.

The tilting of the slats 30 in the opposite direction may be achieved by reversing the direction of rotation of output shaft 73 of motor assembly 70.

In one embodiment, the PCBA 130 is configured to detect engagement of the plunger 122 of actuator 120 and the internal gear 114. Upon detection of engagement of the plunger 122 and internal gear 114, the PCBA enacts firmware to activate the motor assembly 70. This way, upon instructions to tilt the slats 30, the motor assembly 70 will not be activated until the plunger 122 engages the internal gear 114. This prevents the unintended retraction or extension of slats 30, which would occur if motor assembly 70 is activated while plunger 122 is not engaged with internal gear 114, as described above.

It will be apparent to those skilled in the art that various modifications and variations can be made in the oscillation and retraction mechanism for window blinds of the present invention without departing from the spirit or scope of the invention. Thus, it is intended that the present invention covers modifications and variations of this invention provided they come within the scope of the appended claims and their equivalents.

What is claimed is:

1. A window covering assembly comprising:
a header;
a bottom rail;
a ladder disposed between the header and the bottom rail and comprising:
two vertical components;
a plurality of horizontal components disposed between the two vertical components;
a suspension cord disposed between the header and bottom rail;
a plurality of slats held by the ladder;
an oscillation and retraction mechanism comprising:
a motor assembly; and
a planetary gear assembly comprising
a sun gear;
two planetary gears, each having extensions protruding therefrom; and
an internal gear; and
an actuator, wherein
the two vertical components of the ladder are respectively attached to the extensions protruding from the two planetary gears, and
the suspension cord is fixed to an outside of the internal gear.

2. The window covering assembly according to claim 1, further comprising a transmission between the motor assembly and the oscillation and retraction mechanism.

3. The window covering assembly according to claim 2, wherein the transmission comprises two spur gears.

4. The window covering assembly according to claim 1, wherein the internal gear comprises:
a small-diameter segment; and
a large-diameter segment, wherein
the suspension cord is attached to the outside of the small-diameter segment, and
the sun gear and planetary gears are at least partially housed in the large-diameter component.

5. The window covering assembly according to claim 1, wherein the actuator is a solenoid comprising a solenoid body and a plunger.

6. The window covering assembly according to claim 5, wherein the plunger of the solenoid has a predetermined stroke length and the solenoid is arranged such that a distance between the internal gear and the solenoid is less than the stroke length.

7. The window covering assembly according to claim 6, further comprising a printed circuit board assembly for controlling the actuator and motor assembly.

8. The window covering assembly according to claim 7, wherein the printed circuit board assembly is configured to detect engagement of the plunger and the internal gear and, upon such detection, activate the motor assembly.
